(19) United States
(12) Patent Application Publication
(10) Pub. No.: US 2008/0099625 A1
(43) Pub. Date: May 1, 2008

(54) First satellite sub-constellation and offset second satellite sub-constellation

(76) Inventor: Darrell Franklin Yocom, Lakewood, CA (US)

Correspondence Address: PATTI, HEWITT & AREZINA LLC, ONE NORTH LASALLE STREET, 44TH FLOOR, CHICAGO, IL, 60602, US

(21) Appl. No.: 11/546,720

(22) Filed: Oct. 12, 2006

(51) Int. Cl. B64G 1/10

(52) U.S. Cl. 244/158.4

(57) ABSTRACT

A satellite constellation in one example comprises a first set of satellites configured in a first sub-constellation defined by a first set of orbital elements. The satellite constellation further comprises a second set of satellites configured in a second sub-constellation defined by the first set of orbital elements with a longitudinal offset.

### TECHNICAL FIELD

The invention relates generally to satellites and more particularly to satellite constellations.

### BACKGROUND

Satellite networking can be accomplished through geostationary or inclined-orbit satellites. Geostationary satellites are expensive and distant, may require a heavier communication payload in the mission satellite, incur a substantial speed-of-light communication delay, and are often already heavily tasked. An inclined-orbit satellite, usually in a low Earth Orbit (“LEO”) or a Medium Earth Orbit (“MEO”), may not always be positioned or equipped to contribute to the mission of the mission satellite, resulting in reduced cost efficiency. Inclined-orbit satellites can store messages during times when there is no communications path toward the ground, transmitting them when such a path becomes available, but this can introduce large latencies, on the order of several minutes. To reduce these latencies, ground stations could be deployed in great numbers around the world, but they usually require manning and are vulnerable to attack, and it may not be possible politically to place them in all the optimum locations.

### DESCRIPTION OF THE DRAWINGS

Features of example implementations of the invention will become apparent from the description, the claims, and the accompanying drawings in which:

FIG. 1 is a representation of one implementation of a snake family 1 satellite constellation.

FIG. 2 is a representation of one implementation of a snake family 2 satellite constellation.

FIG. 3 is a representation of one implementation of a snake family 3 satellite constellation.

FIG. 4 is a representation of one implementation of an apparatus that comprises a dual snake satellite constellation.

FIG. 5 is a representation of one implementation of a satellite of the dual snake satellite constellation of FIG. 4.

### DETAILED DESCRIPTION

Goals for satellite constellation design comprise good ground coverage that is consistent throughout the orbit, constant network connectivity to every live satellite, robust and fault-tolerant communication, fast communication to any satellite, multiple paths to any satellite, and permanent crosslinks between satellites.

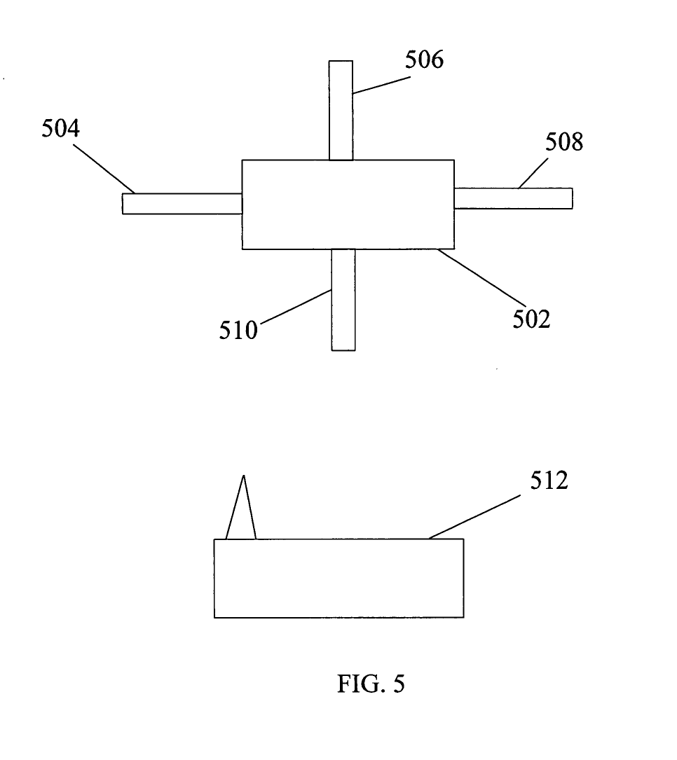

Three approaches to constellation design comprise Walker, Polar “Star”, and Equatorial (e.g., geosynchronous) constellations. Geosynchronous satellites have little movement relative to the fixed earth. However, for whole-earth coverage, equatorial constellations may be inappropriate, since they do not provide polar coverage (e.g., coverage at higher latitudes). Due to their distance from the earth, equatorial satellites have an increased speed-of-light propagation delay and may require more communication power or larger antennas to communicate with ground stations 512 (FIG. 5). In addition, there is a limited availability of equatorial slots for satellites to avoid collisions and interference between separate constellations. Star constellations (e.g., “streets of coverage” constellations) may provide whole-earth ground coverage, but have better coverage near the poles than at the equator, which is the opposite of what most systems require.

For many earth-observing or LEO communications systems, a Walker constellation may be selected with an emphasis on ground coverage rather than robust satellite networking. Double-Walker constellations offer slightly less ground coverage than the best single Walker design for the same number of satellites and thus were not previously used. To increase the constellation size, some solutions considered repositioning older satellites into new planes after newer ones have been launched, in order to create a new Walker constellation optimized for the larger number of satellites. Other solutions considered simply adding satellites to the existing planes and rephasing within the plane. The first approach burns a lot of fuel, shortening the remaining life of the satellites, and the second may result in a less-than-optimum final constellation. Some solutions of satellite networking, particularly for small Walker constellations on the order of 20 satellites, depended on a mix of permanent and transient links. Permanent links are preferred to transient links because 1) they do not incur an outage during the time required to make/break a transient link, and 2) due to their permanence, no message will ever have to be truncated or rerouted due to an impending switch, 3) there are times when the number of transient and permanent links available is less than the number of crosslink antennas available, resulting in wasted capacity.

It is desirable to develop a constellation of low earth orbit (“LEO”) satellites as part of a military earth-observing system. This constellation in one embodiment employs highly-reliable self-relay networking.

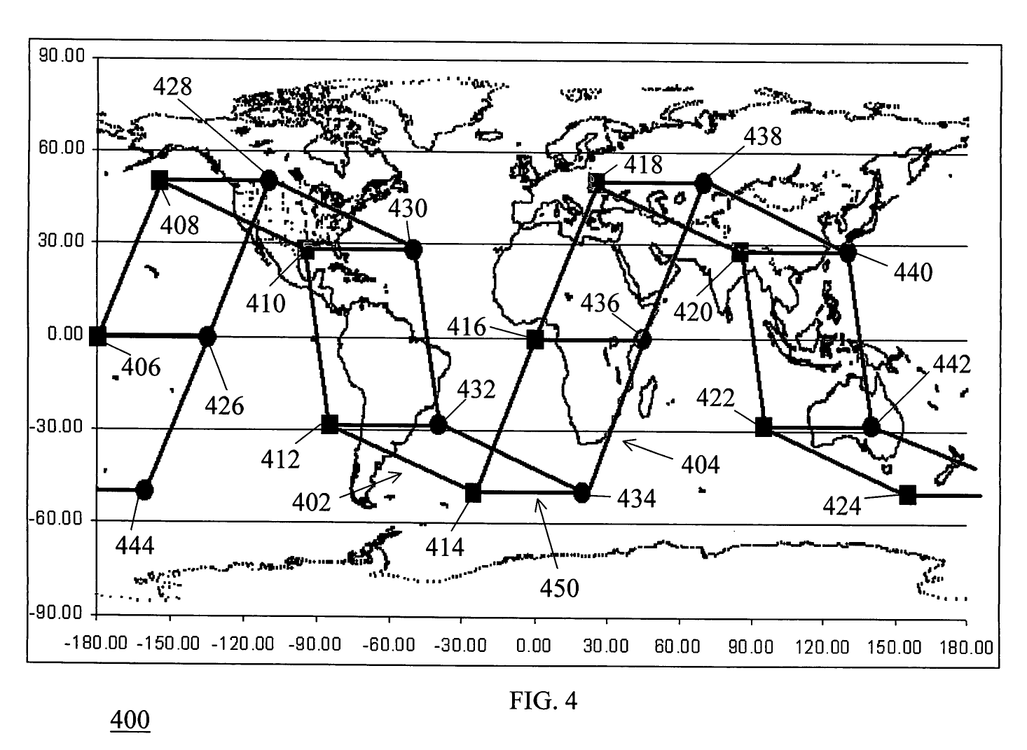

Most satellite constellations in use today employ satellites in a regular pattern, known as a Walker Delta Constellation (aka Walker constellation, aka Rosette constellation). In one embodiment, for a given number of satellites, N, instead of forming the “optimal” Walker constellation with N satellites, if one wants robust networking, one should create a first sub-constellation 402 (FIG. 4) of the optimal networked Walker constellation for N/2 satellites, then launch it twice, with a second sub-constellation 404 (FIG. 4) offset in longitude from the first, where the offset is small enough such that the equivalent satellites in each sub-constellation form a permanently-connected pair across their entire orbit. This configuration of the first and second sub-constellations 402 and 404 reduces or eliminates traveling holes in coverage that may occur in a single Walker constellation. The single Walker constellation may also lose connectivity if two satellites are inoperable.

One family of Walker constellations, in particular, which John Walker called a “sigma”, others call a “wave”, and referred to herein as a “snake”, has a pattern in which the current locations of satellites projected onto the ground trace out sine waves of sub-satellite ground points, with the satellites in a continuous train that loops around the world such that each satellite can always access the satellite ahead and behind it in the train. Because of this constant access, permanent communications links are possible between consecutive satellites in the snake. The satellites of a snake constellation do not cross paths. Accordingly, there is no duplication of ground coverage or risk of collision or interference. The number of satellites in the constellation determines how closely the satellites are spaced along the snake.

A satellite's orbit is described by a set of parameters known as its orbital elements. Some embodiments apply to constellations with satellites that all operate at the same altitude, at the same inclination, and in circular orbits. Given a single “root” satellite's orbital elements, a Walker constellation can be specified by three numbers, T/P/F. T is the total number of satellites in the constellation. P is the number of orbital planes employed (spaced regularly around the earth), and F is the phasing parameter, which specifies the relative position of satellites in adjacent planes.

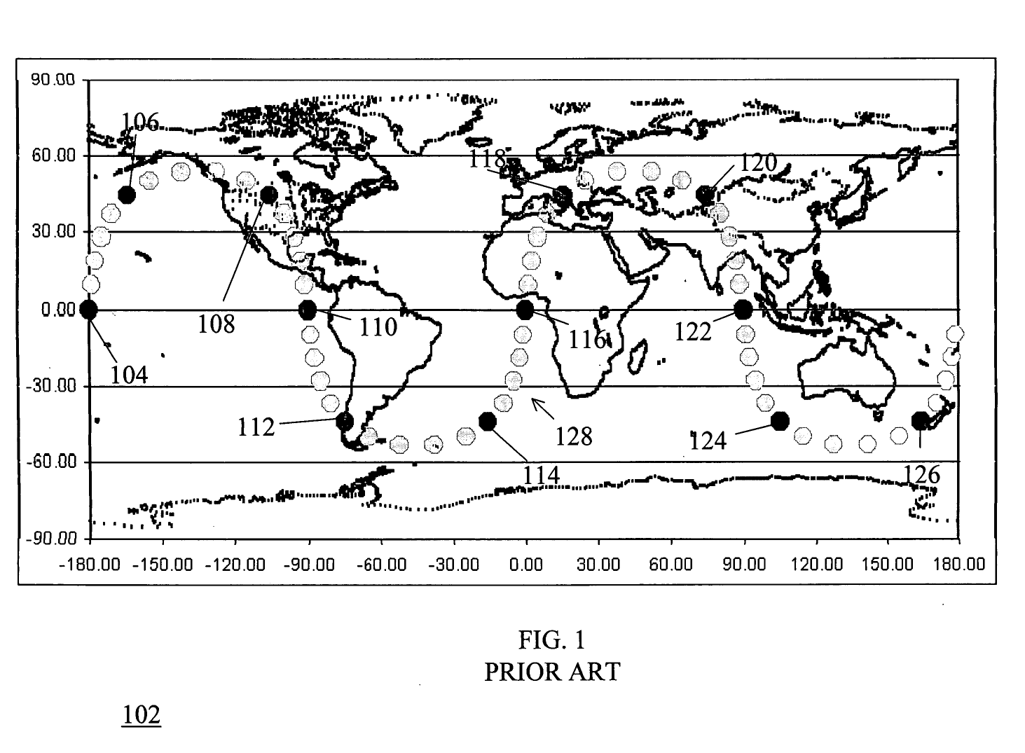

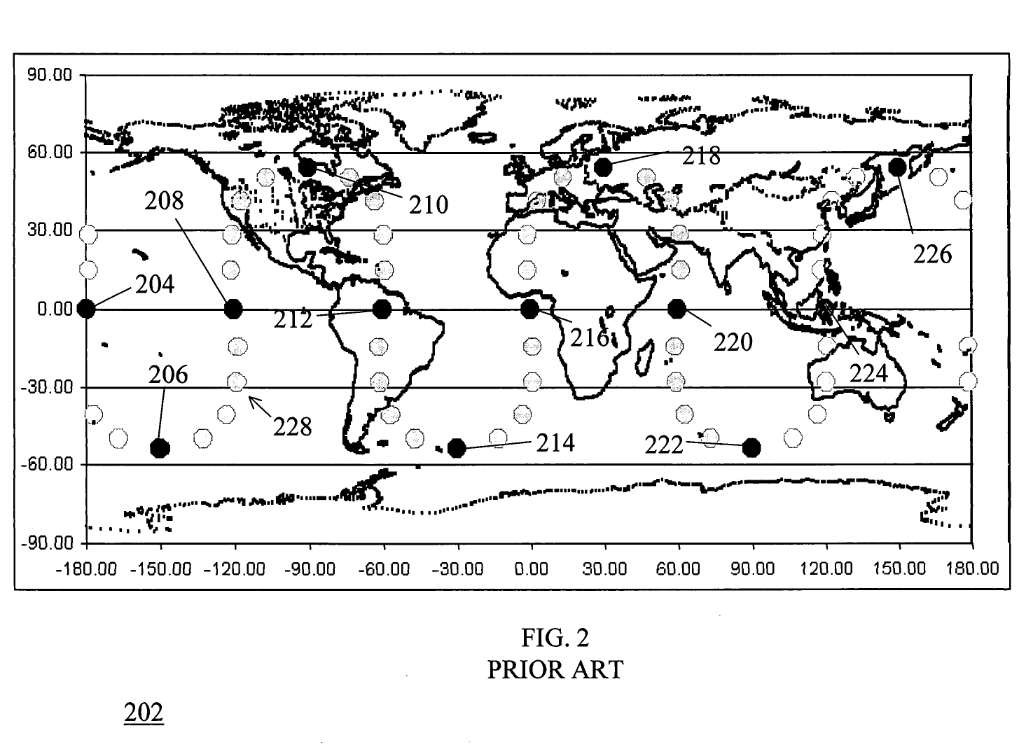

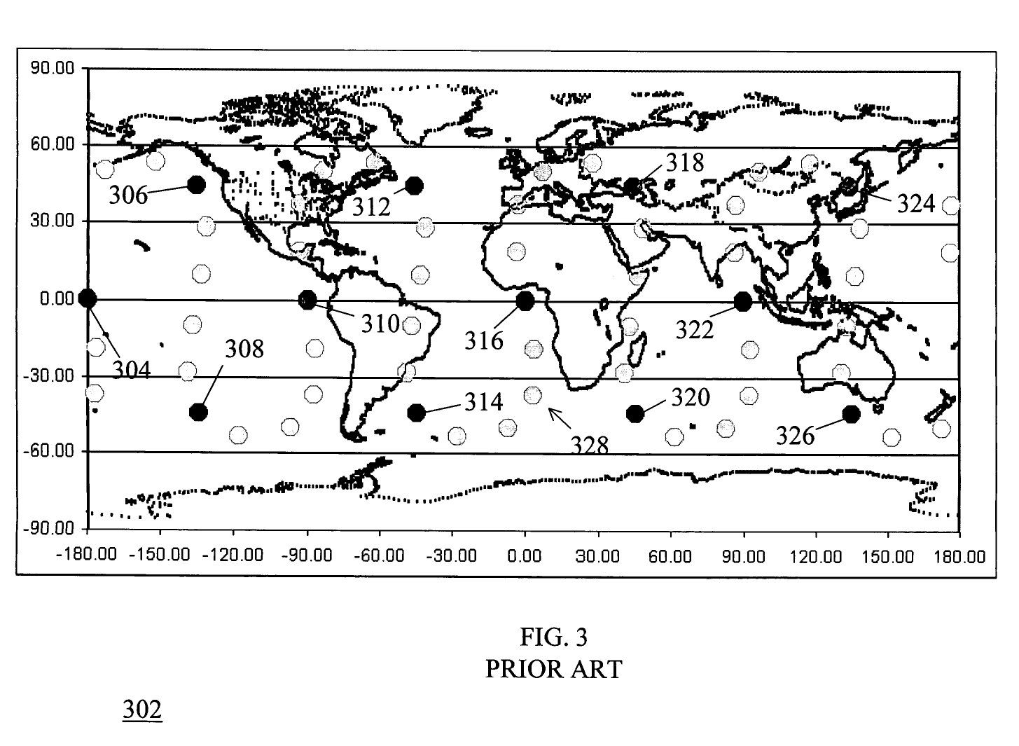

One general formula that produces Snake constellations (a more inclusive formula is described in Walker, 1984) is: T=N P=N/S F=P−S−1 Where S is referred to as a Snake Family Parameter, and is an integer greater than or equal to one, which divides evenly into N, the total number of satellites. The number of gaps created by such a snake is ((S+1)*2). The gaps occur regularly spaced around the world at intervals of (180/(S+1)) degrees, starting with a relative longitude of (90/(S+1)) degrees. For instance, using this formula for the S=1 family, any constellation N/N/N−2 is a snake with 4 gaps (at 45, 135, 215, and 305 degrees longitude relative to the root satellite). (Note: snake patterns with higher numbers of gaps have smaller gaps). Each snake forms a ring of satellites that connects to itself. If the number of satellites is large enough so that each satellite can always access its leader and follower, communications all around the ring can be accomplished by sending messages between consecutive pairs of satellites in the ring until the destination satellite is reached. One useful snake configuration for ground coverage is a 27/9/5 snake, a Family 3 snake, since 27/9 equals 3. Each snake family features a unique sinusoidal set of initial satellite positions, and regardless of the number of satellites in the particular constellation, they will all lie along the sinusoidal wave pattern defined by the family number. This set of initial positions, occurring in a sinusoidal pattern, should not be confused with the different sinusoidal ground trace each satellite will make while in motion. FIG. 1, FIG. 2, and FIG. 3 illustrate initial locations for satellites of snake families 1 through 3, respectively, relative to a root satellite at latitude and longitude zero.

Turning to FIG. 1, a prior art satellite constellation 102 comprises twelve satellites 104, 106, 108, 110, 112, 114, 116, 118, 120, 122, 124, and 126. The satellite constellation 102 comprises a Family 1 snake family (e.g., N/N/N−2) with the satellites configured according to a 12/12/10 pattern. For clarity, an additional set of initial locations 128 of a 60/60/58 pattern is shown overlaid with the satellite constellation 102 to better illustrate the underlying sinusoidal pattern of initial positions that all Family 1 snakes follow.

Turning to FIG. 2, a prior art satellite constellation 202 comprises twelve satellites 204, 206, 208, 210, 212, 214, 216, 218, 220, 222, 224, and 226. The satellite constellation 202 comprises a Family 2 snake family (i.e., N/(N/2)/(N/2)−3) with the satellites configured according to a 12/6/3 pattern. For clarity, an additional set of initial locations 228 of a 60/30/27 pattern is shown overlaid with the satellite constellation 202 to better illustrate the underlying sinusoidal pattern of initial positions that all Family 2 snakes follow.

Turning to FIG. 3, a prior art satellite constellation 302 comprises twelve satellites 304, 306, 308, 310, 312, 314, 316, 318, 320, 322, 324, and 326. The satellite constellation 302 comprises a Family 3 snake family (e.g., N/(N/3)/(N/3)−4) with the satellites configured according to a 12/4/0 pattern. For clarity, an additional set of initial locations 328 of a 60/20/16 pattern is shown overlaid with the satellite constellation 302 to better illustrate the underlying sinusoidal pattern of initial positions that all Family 3 snakes follow.

A hybrid constellation in one example comprises two snake sub-constellations with equal inclinations and altitudes, with a longitude offset between them, said offset being half of the gap between lobes of the sinusoidal set of initial positions of satellites of the first snake. For example, the offset amount is ¼ of a snake wave: Family 1: 45 degrees; Family 2: 30 degrees; Family 3: 22.5 degrees. By introducing the offset sub-constellation, each satellite in each snake has a “buddy” in the next snake through which it can communicate, and since the orbits are equivalent, both satellites are always approximately at the same latitude, so the buddy always orbits alongside and is permanently accessible. This gives each satellite a permanent link into the other sub-constellation. A single snake constellation will break its network connectivity if two satellites fail, but by having two parallel snakes, the proposed network can patch around failures, making it very robust. For example, the constellation can maintain connectivity when yaw obscures one antenna. And since the second snake fills the ground coverage gaps in the first, ground coverage is maximized, too. Any Walker constellation would benefit from having a buddy constellation.

Turning to FIG. 4, a satellite constellation 400 in one embodiment comprises a first sub-constellation 402 (shown as squares) and a second sub-constellation 404 (shown as circles). Sub-constellation 402 comprises a first set of satellites 406, 408, 410, 412, 414, 416, 418, 420, 422, and 424. Sub-constellation 404 comprises a second set of satellites 426, 428, 430, 432, 434, 436, 438, 440, 442, and 444. In this example, each satellite in each constellation has a communications link, such as 450, to its buddy satellite in the other constellation. Each satellite flies at approximately the same altitude and orbital inclination, and flies in a roughly circular orbit (e.g., eccentricity near zero). The sub-constellations 402 and 404 in one example are in low to medium earth orbit, with altitudes ranging from several hundred kilometers to several thousand kilometers. As it orbits the earth, each satellite in sub-constellation 402 traces out an approximately sinusoidal ground trace. Each satellite of sub-constellation 404 follows the same ground trace as its buddy satellite in constellation 402, at the same latitude but with a longitudinal offset, as will be appreciated by those skilled in the art. For example, the first sub-constellation is defined by a first set of orbital elements and the second sub-constellation is defined by the first set of orbital elements with a longitudinal offset.

The satellites of the sub-constellations 402 and 404 in one example carry three crosslink antennas (capable of communicating with the other satellites) and one groundlink antenna (capable of communicating with a ground site). The antenna may be a radio frequency antenna, a laser transmitter/receiver, electromagnetic wave transmitter/receiver, or other means for line-of-sight communication with other satellites or ground stations 512 (FIG. 5).

The satellite 416 comprises a root satellite of the first sub-constellation 402. The satellite 436 comprises a root satellite of the second sub-constellation 404. The satellite 416 is offset in longitude (or equivalently, Right Ascension) from the satellite 436 by (90/(S+1)) degrees, such that the satellite 436 is placed in the middle of the first gap of the first sub-constellation 402 east of the satellite 416. With this offset, each satellite of the first sub-constellation 402 is communicatively coupled with one satellite of the second sub-constellation 404. For example, each satellite in the sub-constellation 402 has a “buddy” in the sub-constellation 404 that flies in formation with it. For example, the satellite 408 of the first sub-constellation 402 has the satellite 428 of the second sub-constellation 404 as a buddy. Each pair of buddy satellites in one example is communicatively coupled. In one example, each satellite in the first sub-constellation 402 and the second sub-constellation 404 is part of a buddy pair. In a further example, each satellite is communicatively coupled with its leader and follower. For example, the satellite 408 employs the three crosslink antennas for communication links to the previous satellite 406 (e.g. follower), next satellite 410 (e.g., leader), and buddy satellite 428, as will be appreciated by those skilled in the art.

The altitude of the satellite constellation 400 must be sufficient that this offset does not prevent communications between the two “buddy” satellites at any point in the orbit (if, for instance the communication system requires a line of sight 100 km above the earth's surface, the satellite constellation 400 must be no lower than about 640 km altitude for an S=1 constellation). The sub-constellations 402 and 404 must have enough satellites such that each pair of consecutive satellites (e.g., satellites 410 and 412, or satellites 416 and 418) in its snake can maintain constant communications. This number will depend on the capability of the communications system and on the altitude of the satellite constellation 400 (for instance, to maintain a line of sight 100 km above the earth's surface at an orbital altitude of 1200 km requires at least 10 satellites in an S=1 snake). These calculations can be easily made by those skilled in the art.

The satellite constellation 400 may provide one or more of: 1) Fault-tolerant networking. A large number of random failures have to occur before complete connectivity to the remaining live satellites is lost. 2) All satellite-to-satellite links are permanent. This is a huge advantage over Walker constellations that must make and break transient links. 3) Additional communications paths. Because of the large number of interconnections, there are a multitude of paths for messages (or packets of data) to take. This can result in decreased communications time. 4) Constellation Buildup. As soon as the first snake sub-constellation 402 is launched, it becomes fully operational, albeit with limited communications redundancy and gaps in its earth coverage. But as each additional satellite is orbited into the second snake sub-constellation 404, it becomes fully capable and automatically part of the entire network, through its “buddy”. 5) Pre-existing satellites never have to move to re-optimize the constellation, resulting in fuel savings and an increase in mission lifetime. 6) Other Walker constellations other than the Snake may also benefit from the presence of an identical constellation, offset in longitude. 7) Since all antennas make a permanent connection to another satellite, the spacecraft communications system is always operating at full capability.

The satellite constellation 400 may comprise alternative embodiments and configurations that employ a plurality of offset (e.g., shifted) sub-constellations. Any additional sub-constellation need not be fully populated to contribute to network robustness. In fact, it need not even have the same Walker parameters as the first, as long as it is in the same Snake Family, S.

Satellite constellations that may benefit comprise satellites that perform earth observing (e.g., radar, IR, visual) or telephone/data-relay services, for example, Space Tracking and Surveillance System (STSS), Space-Based Radar, Space-Based Laser, Space-Based Surveillance System (SBSS).

Turning to FIG. 5, a satellite 502 in one example comprises first, second, third, and fourth antennas 504, 506, 508, and 510. The satellite 502 comprises one implementation of the satellites of sub-constellations 402 and 404. The antennas 504, 506, 508, and 510 comprise means for communication with other satellites 502 and/or ground stations 512, for example, radio frequency antennas, laser transmitter/receivers, electromagnetic wave transmitter/receiver, or others, as will be appreciated by those skilled in the art. The antennas 504, 506, and 508 in one example comprise crosslink antennas for communication with other satellites. The antenna 510 in one example comprises a groundlink antenna for communication with one or more ground stations 512.

What is claimed is:

1. A satellite constellation, comprising:
a first set of satellites configured in a first sub-constellation defined by a first set of orbital elements; and
a second set of satellites configured in a second sub-constellation defined by the first set of orbital elements with a longitudinal offset.

2. The satellite constellation of claim 1, wherein the first set of satellites and the second set of satellites comprise an approximately same altitude and orbital inclination and follow an approximately circular orbit.

3. The satellite constellation of claim 1, wherein the first sub-constellation and the second sub-constellation comprise a Walker configuration.

4. The satellite constellation of claim 3, wherein the Walker configuration comprises a snake (“sigma”) configuration defined by T/P/F where N is equal to a number of satellites and S is a snake family parameter.

5. The satellite constellation of claim 4, wherein the longitudinal offset is substantially equal to 90/(S+1) degrees.

6. The satellite constellation of claim 1, wherein each satellite of the first set of satellites comprises a buddy communication link with a satellite of the second set of satellites.

7. The satellite constellation of claim 6, wherein the first set of satellites and the second set of satellites comprises a same number of satellites;
wherein each satellite of the second set of satellites comprises a buddy communication link with one satellite of the first set of satellites in a one-to-one relationship.

8. The satellite constellation of claim 6, wherein each satellite of the second set of satellites comprises a forward communication link with a next satellite of the second set of satellites and comprises a reverse communication link with a previous satellite of the second set of satellites.

9. The satellite constellation of claim 8, wherein the first set of satellites and the second set of satellites comprises a same number of satellites;
wherein each satellite of the second set of satellites comprises a buddy communication link with one satellite of the first set of satellites in a one-to-one relationship;
wherein each satellite of the first set of satellites comprises a forward communication link with a next satellite of the first set of satellites and comprises a reverse communication link with a previous satellite of the first set of satellites.

10. The satellite constellation of claim 9, wherein each of the buddy communication links comprise substantially permanent buddy communication links.

11. The satellite constellation of claim 10, wherein each of the forward communication links comprise substantially permanent forward communication links;
wherein each of the reverse communication links comprises substantially permanent reverse communication links.

12. A satellite constellation, comprising:
a plurality of satellite buddy pairs configured in a first sub-constellation and a second sub-constellation;
wherein each satellite buddy pair comprises a first satellite of the first sub-constellation and a second satellite of the second sub-constellation that are coupled by a buddy communication link;
wherein the first sub-constellation comprises a Walker snake configuration;
wherein the second sub-constellation comprises the Walker snake configuration with a longitudinal offset.

13. The satellite constellation of claim 12, wherein the Walker snake configuration comprises initial locations that substantially follow a ground trace that comprises periodic lobes;
wherein the longitudinal offset is approximately equal to one half a distance between consecutive lobes.

14. The satellite constellation of claim 13, wherein the first sub-constellation and the second sub-constellation comprise an approximately same altitude and orbital inclination and follow an approximately circular orbit.

15. The satellite constellation of claim 12, wherein each satellite of the first sub-constellation comprises a forward communication link with a next satellite of the first sub-constellation;
wherein each satellite of the first sub-constellation comprises a reverse communication link with a previous satellite of the first sub-constellation;
wherein each satellite of the second sub-constellation comprises a forward communication link with a next satellite of the second sub-constellation;
wherein each satellite of the second sub-constellation comprises a reverse communication link with a previous satellite of the second sub-constellation.

16. The satellite constellation of claim 15, wherein each buddy communication link, forward communication link, and reverse communication link comprises a substantially permanent communication link.

17. A method, comprising the steps of:
launching a first satellite sub-constellation that comprises a plurality of satellites in a Walker snake configuration;
establishing a forward communication link between each satellite of the first satellite sub-constellation and a next satellite of the first satellite sub-constellation;
establishing a reverse communication link between each satellite of the first satellite sub-constellation and a previous satellite of the first satellite sub-constellation;
launching at least one satellite into a second satellite sub-constellation that is longitudinally offset from the Walker snake configuration of the first satellite sub-constellation;
establishing a buddy communication link between the at least one satellite and a corresponding satellite of the first satellite sub-constellation.

18. The method of claim 17, wherein the plurality of satellites of the first satellite sub-constellation comprises a first plurality of satellites, wherein the step of launching the at least one satellite into the second satellite sub-constellation that is longitudinally offset from the Walker snake configuration of the first satellite sub-constellation comprises the step of:
launching into the second sub-constellation a second plurality of satellites that correspond to the first plurality of satellites, wherein the first plurality of satellites and the second plurality of satellites comprise a same number of satellites;
wherein the step of establishing the buddy communication link between the at least one satellite and the corresponding satellite of the first satellite sub-constellation comprises the step of:
establishing a buddy communication link between each satellite of the first plurality of satellites a corresponding satellite of the second plurality of satellites;
the method further comprising the steps of:
establishing a forward communication link between each satellite of the second satellite sub-constellation and a next satellite of the second satellite sub-constellation;
establishing a reverse communication link between each satellite of the second satellite sub-constellation and a previous satellite of the second satellite sub-constellation.

19. The method of claim 18, further comprising the step of:
sending a message from a first satellite of the first satellite sub-constellation to a second satellite of the second satellite sub-constellation over at least one buddy communication link.

20. The method of claim 19, wherein the step of sending the message from the first satellite in the first satellite sub-constellation to the second satellite of the second satellite sub-constellation over the at least one buddy communication link comprises the step of:
bypassing a third satellite of the first satellite sub-constellation to send the message from the first satellite to the second satellite.
